(19) United States
(12) Patent Application Publication
(10) Pub. No.: US 2007/0082977 A1
(43) Pub. Date: Apr. 12, 2007

(54) Ink composition for color-memorizing photochromic writing instrument and writing instrument using the same

(75) Inventors: Yutaka Shibahashi, Nagoya-shi (JP); Michiyuki Yasuda, Nagoya-shi (JP); Masahiro Irie, Fukuoka-shi (JP)

Correspondence Address: SUGHRUE-265550, 2100 PENNSYLVANIA AVE. NW, WASHINGTON, DC, 20037-3213, US

(73) Assignees: THE PILOT INK CO., LTD.; MASAHIRO IRIE

(21) Appl. No.: 11/245,167

(22) Filed: Oct. 7, 2005

(51) Int. Cl. C09D 11/00

(52) U.S. Cl. 523/161

(57) ABSTRACT

An ink composition for a color-memorizing photochromic writing instrument, which comprises a photochromic agent containing a diarylethene photochromic compound dissolved, dispersed or suspended in a vehicle containing at least a solvent and a binder.

### FIELD OF THE INVENTION

The present invention relates to an ink composition for a color-memorizing photochromic writing instrument and a writing instrument using the same. More particularly, it relates to an ink composition for a color-memorizing photochromic writing instrument that gives a handwriting which is allowed to develop color by irradiation with ultraviolet rays or sunlight containing ultraviolet rays, thereby being discolored from colorless to colored or from color (1) to another color (2) and maintained in the discolored state, and can return to the original handwriting showing colorless or color (1) as needed by irradiating the handwriting with visible light, and a convenient writing instrument for effectively forming the aforementioned handwriting.

### BACKGROUND ART

Conventionally, as an ink for writing instrument for forming an image which changes color, those utilizing a thermochromic material (e.g., Patent Document 1) and those utilizing a photochromic material (e.g., Patent Document 2) are known.

For discoloring a writing image formed with the ink utilizing the aforementioned thermochromic material, a heating means or a cooling and heating means is required. On the other hand, a writing image formed with the ink utilizing the photochromic material can be spontaneously discolored by irradiation with sunlight; therefore it does not require effort.
[Patent Document 1]
   JP-A-9-124993
[Patent Document 2]
   JP-A-8-156479

### SUMMARY OF THE INVENTION

The writing image formed with the ink utilizing the aforementioned conventional photochromic material is allowed to develop color by irradiation with sunlight and maintains the coloring state under irradiation with sunlight, however, when it is left at a place which is not irradiated with sunlight, the coloring state is not maintained, and it is spontaneously decolored reversibly to return the original handwriting, and under normal conditions, the coloring state is not maintained.

The present inventors found that, during the process of examining applicability of thermally irreversible photochromic compounds considered to be necessary for optical memory (a color-memorizing photochromic property), a specific photochromic compound (a diarylethene compound) is remarkably excellent in color-memorizing property for maintaining a coloring state, thermal stability, sensitivity, repetition durability and the like and is effective as a photochromic agent for an ink for a writing instrument for giving a color-memorizing photochromic handwriting, and it is effective to apply an ink composition obtained by dissolving, dispersing or suspending the photochromic agent as the form of a writing instrument, thus the present invention has been completed.

The present invention intends to provide an ink composition for a color-memorizing photochromic writing instrument that gives a handwriting which is allowed to develop color by irradiation with ultraviolet rays or sunlight containing ultraviolet rays, thereby being discolored from colorless to colored or from color (1) to another color (2) and maintained in the discolored state, and can return to the original handwriting showing colorless or color (1) as needed by irradiating the handwriting with visible light, and a convenient photochromic writing instrument for effectively forming the aforementioned handwriting.

A requirement of the present invention is an ink composition for a color-memorizing photochromic writing instrument, comprising a photochromic agent containing a diarylethene photochromic compound dissolved, dispersed or suspended in a vehicle containing at least a solvent and a binder.

Another requirement is that the vehicle has a light reflectance of a dry coating film in the wavelength range from 350 nm to 400 nm of 20% or more; the photochromic agent is a microcapsule pigment in which the diarylethene photochromic compound is encapsulated or a resin powder particle containing the photochromic compound; the ink composition further comprises a non-photochromic dye or pigment; the pigment is selected from luster pigments; the ink composition further comprises a shear-thinning material and has a shear-thinning property; the ink composition further comprises a water-soluble polymeric flocculating agent, in which the microcapsule pigments in which the diarylethene photochromic compound is encapsulated or the resin powder particles containing the photochromic compound are suspended in a mildly cohesive state; or the like.

Another requirement is a writing instrument, comprising the aforementioned ink composition for a color-memorizing photochromic writing instrument accommodated in a tubular member, which is constituted so as to enable writing by allowing the ink composition to flow out from a writing tip portion.

Another requirement is that the aforementioned writing instrument is a writing instrument in the form of a ballpoint pen accommodating the ink composition for a color-memorizing photochromic writing instrument in a tubular member; the aforementioned writing instrument is a writing instrument in which the ink composition for a color-memorizing photochromic writing instrument is accommodated in an ink absorber made of a fiber bundle and is allowed to flow out from a pen body made of a processed fiber product; or the like.

### BRIEF DESCRIPTION OF THE DRAWINGS

FIG. 1 is an explanatory longitudinal sectional view showing one example of the form of a ballpoint pen in a color-memorizing photochromic writing instrument of the present invention.

FIG. 2 is an explanatory longitudinal sectional view showing one example of the form of a marking pen having a fiber pen body in a color-memorizing photochromic writing instrument of the present invention.

The Reference Numerals and Signs in the FIGS. are described as follows.
1. Color-memorizing photochromic writing instrument in the form of ballpoint pen
1a. Ball
1b. Tubular member
1c. Color-memorizing photochromic ink (shear-thinning type)
1d. Ink follower
2. Color-memorizing photochromic writing instrument in the form of marking pen
2a. Fiber pen body
2b. Tubular member
2c. Color-memorizing photochromic ink (cohesive type)
2d. Ink absorber

### DETAILED DESCRIPTION OF THE INVENTION

Examples of the aforementioned diarylethene photochromic compound are shown below.

However, the diarylethene photochromic compound to be used in the present invention is not limited to the following compounds.

As the basic skeleton of the diarylethene photochromic compound, compounds represented by the formula (1) can be exemplified.

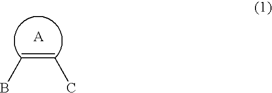

Ring A of the aforementioned general formula (1) represents a hydrocarbon ring or a heterocyclic ring, which may be fluorinated or perfluorinated.

The compounds represented by the aforementioned formula (1) are specifically illustrated with reference to the formula (2) or (3).

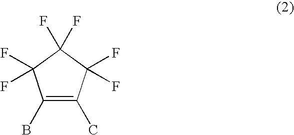

The compounds represented by the aforementioned formula (2) have a ring which contains 5 carbon atoms and may be fluorinated or perfluorinated.

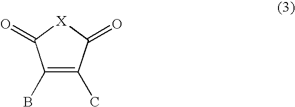

In the compounds represented by the aforementioned formula (3), an anhydrous ring containing 4 carbon atoms is formed, and X represents an oxygen atom or an NR group (wherein R is an alkyl group and/or a hydroxyalkyl group having from 2 to 16 carbon atoms).

In addition, compounds represented by the formula (4) can be exemplified as the basic skeleton of another diarylethene photochromic compound.

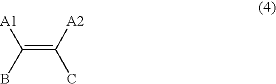

Group A1 and group A2 of the compounds represented by the aforementioned formula (4) always take the cis-form to the double bond, and each independently represents a substituted or unsubstituted alkyl group, a fatty acid ester group or a nitrile group.

The compounds represented by the aforementioned formula (4) are specifically illustrated with reference to the formulae (5) and (6).

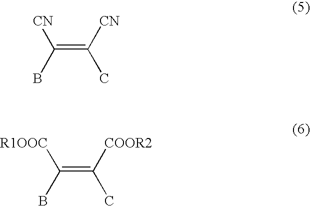

R1 and R2 of the compounds represented by the aforementioned formula (6) represents a methyl group or an ethyl group.

Group B and group C in the compounds represented by the aforementioned formulae (1) to (6) may be the same or different from each other, and groups represented by the following structural formulae can be exemplified. 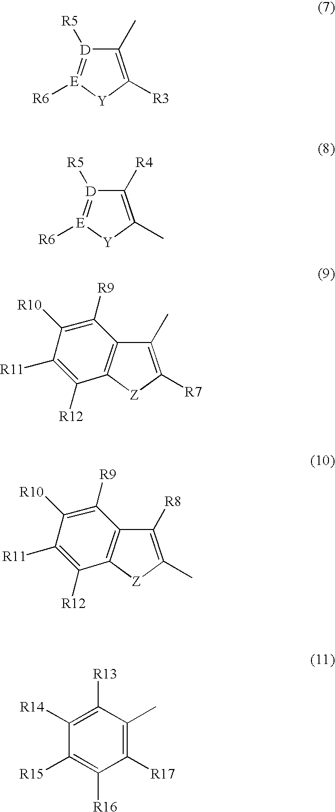
(In these formulae, Y and Z may be the same or different from each other and each represents an oxygen atom, a sulfur atom or an oxidized form of sulfur, nitrogen or selenium, D and E may be the same or different from each other and each represents a carbon atom or a nitrogen atom, R3 to R17 may be the same or different from one another and each represents hydrogen, a linear or branched chain alkyl or alkoxy group having from 1 to 16 carbon atoms, a halogen atom, a linear or branched chain fluoro or perfluoro group having from 1 to 4 carbon atoms, a carboxylate group, an alkyl carboxylate group having from 1 to 16 carbon atoms, a mono or di-alkylamino group having from 1 to 16 carbon atoms, a nitrile group, a phenyl group, a naphthalene group or a heterocyclic compound (pyridine, quinoline, thiophene, furan, indole, pyrrole, selenophene, thiazole, benzothiophene or the like). However, when D and E are a nitrogen atom, R5 and R6 are not present. Between the double bond and groups B and C, a group other than hydrogen, for example, CH₃, CN or CO₃C₂H₆, must always be present at the ortho position to the bond, R3 or R4 must be other than hydrogen, and R7 or R8 must be other than hydrogen in the same manner. Regarding R13 to R17, they may be a naphthalene skeleton formed by bonding the ring with an adjacent group.)

More specific examples of the aforementioned group B and group C include the following compounds.

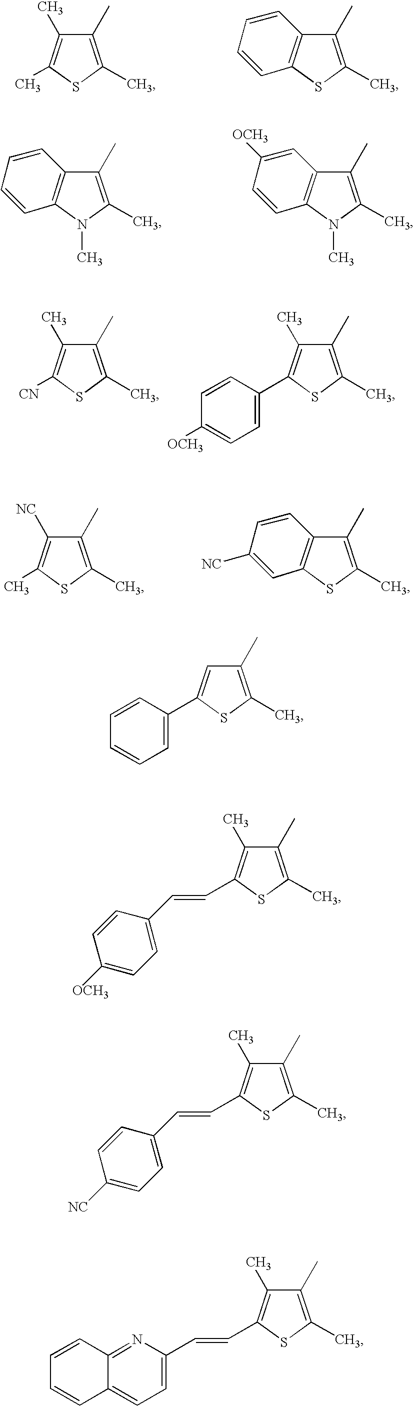

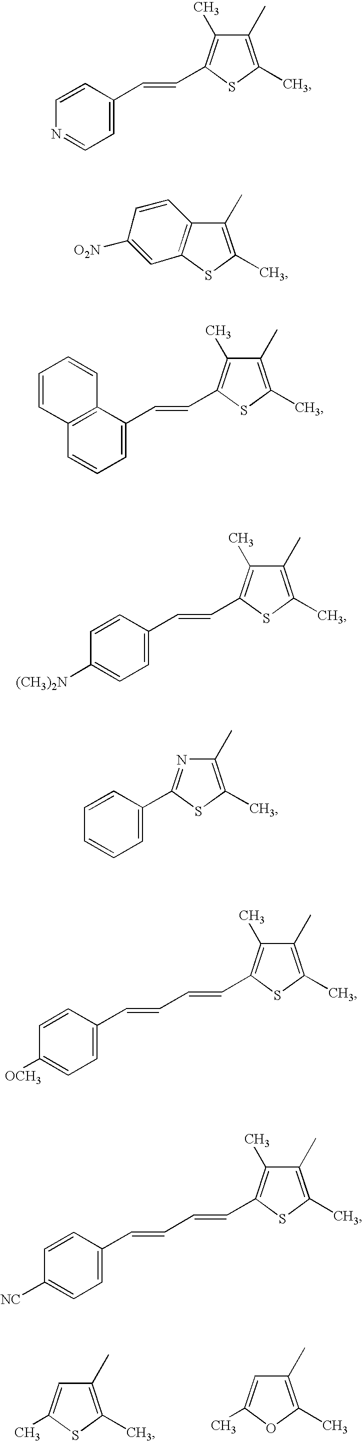

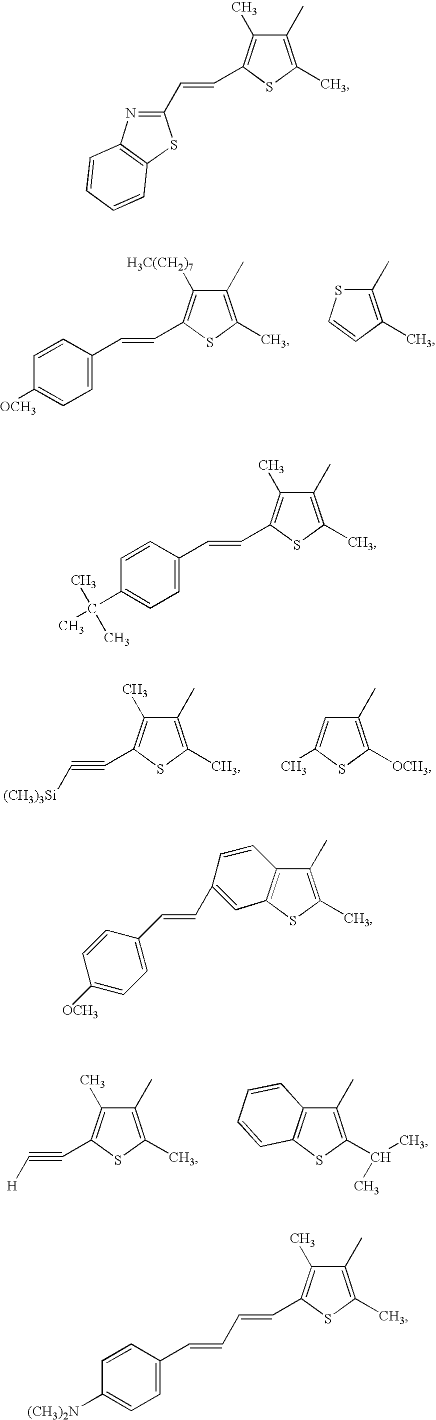

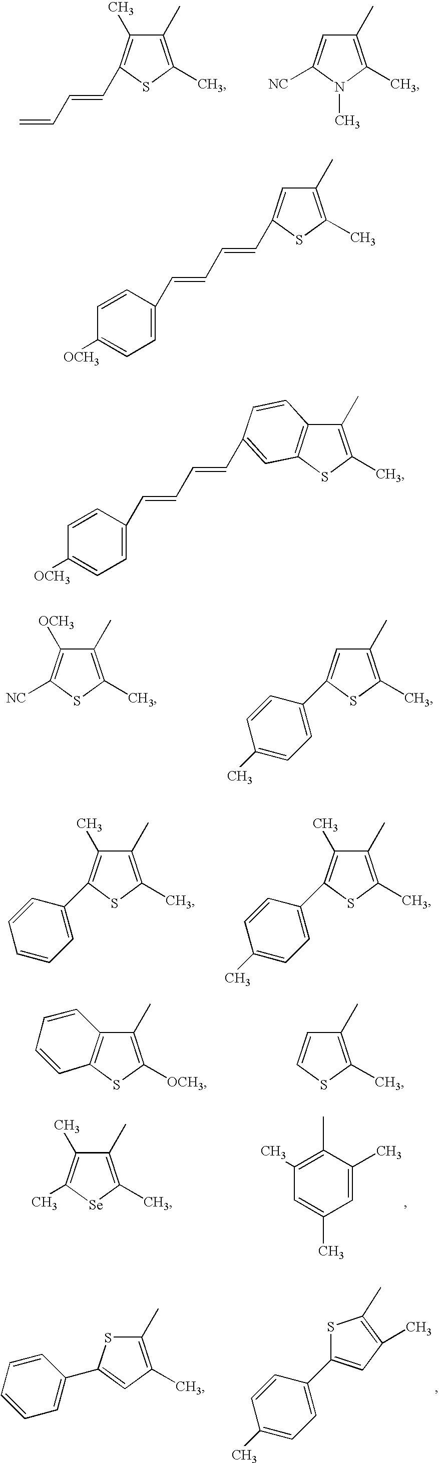

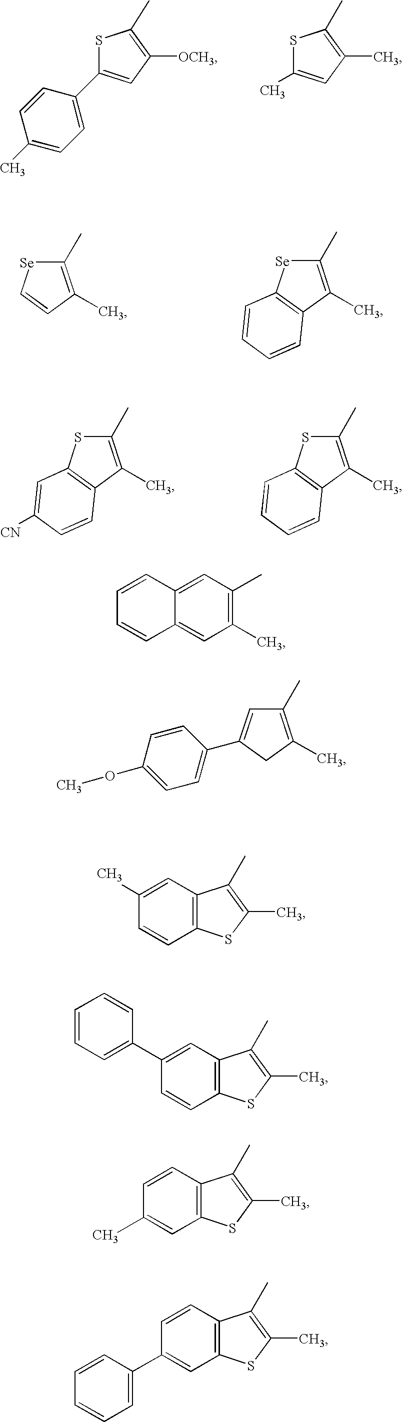

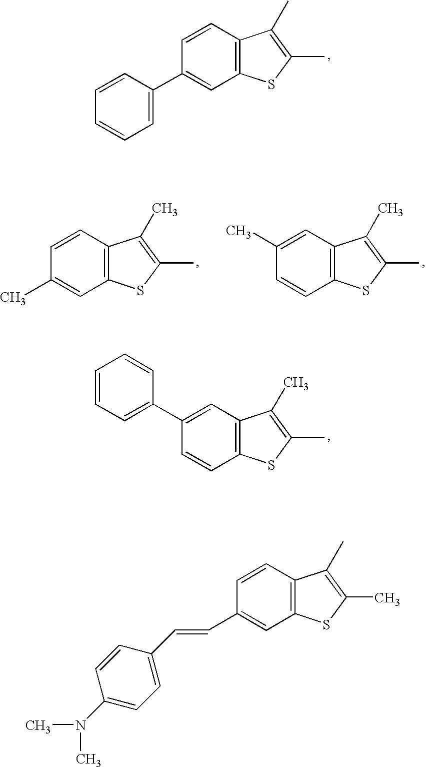

Further illustrating the compounds represented by the aforementioned general formula (2) or (3), as a maleic anhydride compound, 3,4-bis(1,2-dimethyl-3-indolyl)-furan-2,5-dion, 3,4-di(2-methyl-3-benzothiophene)-furan-2,5-dion and the like can be exemplified.

As a cyclopentene compound, 1-(1,2-dimethyl-indolyl)-2-(2-cyano-3,5-dimethyl-4-thienyl)-3,3,4,4,5,5-hexafluorocyclopentene, 1-(1,2-dimethyl-3-indolyl)-2-(3-cyano-2,5-dimethyl-4-thienyl)-3,3,4,4,5,5-hexafluorocyclopentene, 1-(1,2-dimethyl-3-indolyl)-2-(2-methyl-3-benzothienyl)-3,3,4,4,5,5-hexafluorocyclopentene, 1,2-bis(5-(4- methoxyphenyl)-2,4-dimethyl-3-thienyl)-3,3,4,4,5,5-hexafluorocyclopentene, 1,2-bis(5-(2-(4-methoxyphenyl)-1-ethenyl)-2,4-dimethyl-3-thienyl)-3,3,4,4,5,5-hexafluorocyclopentene, 1,2-bis(5-(2-(4-cyanophenyl)-1-ethenyl)-2,4-dimethyl-3-thienyl)-3,3,4,4,5,5-hexafluorocyclopentene, 1,2-bis(2,4-dimethyl-5-(2-(2-quinolyl)-1ethenyl)-3-thienyl)-3,3,4,4,5,5- hexafluorocyclopentene, 1,2-bis(2,4-dimethyl-5-(2-(4-pyridyl)-1ethenyl)-3-thienyl)-3,3,4,4,5,5-hexafluorocyclopentene, 1,2-bis(2,4-dimethyl-5-(2-(1-naphthyl)-1ethenyl)-3-thienyl)-3,3,4,4,5,5- hexafluorocyclopentene, 1,2-bis (5-(2-(4-methoxyphenyl)-1-ethenyl)-2-methyl-4-octyl-3-thienyl)-3,3,4,4,5,5-hexafluorocyclopentene, 1,2-bis(5-(2-(4-t-butylphenyl)-1ethenyl)-2,4-dimethyl-3-thienyl)-3,3,4,4,5,5-hexafluorocyclopentene, 1,2-bis(2,4-dimethyl-5-(2-(2-benzothiazyl)-1ethenyl)-3-thienyl)-3,3,4,4,5,5-hexafluorocyclopentene, 1-(6-(2-(4- methoxyphenyl) -1-ethenyl)-2-methyl-3-benzothienyl)-2-(5-(4-(4-dimethylaminophenyl)-1,3-butadienyl)-2,4-dimethyl -3-thienyl)-3,3,4,4,5,5-hexafluorocyclopentene, 1-(6-(4-(4-methoxyphenyl)-1,3-butadienyl)-2-methyl-3-benzothienyl)-2-(5-(4-(4-methoxyphenyl)-1,3-butadienyl)-2,4-dimethyl-3-thienyl)-3,3,4,4,5,5-hexafluorocyclopentene, 1,2-bis(6-(4-(4-methoxyphenyl)-1,3-butadienyl)-2-methyl-3-benzothienyl)-3,3,4,4,5,5-hexafluorocyclopentene, 1,2-bis(6-(2-(4-methoxyphenyl)-1-ethenyl)-2-methyl-3-benzothienyl)-3,3,4,4,5,5-hexafluorocyclopentene, 1-(6-(2-(4-dimethylaminophenyl)-1-ethenyl)-2-methyl-3-benzothienyl)-2-(5-(2-(4-cyanophenyl)-1-ethenyl) -2,4- dimethyl-3-thienyl)-3,3,4,4,5,5-hexafluorocyclopentene, 1-(6-(2-(4-methoxyphenyl)-1ethenyl)-2-methyl-3-benzothienyl)-2-(5-(2-(4-cyanohenyl)-1ethenyl)-2,4- dimethyl-3-thienyl) -3,3,4,4,5,5-hexafluorocyclopentene, 1-(6-(2-(4-methoxyphenyl)-1-ethenyl)-2-methyl-3-benzothienyl)-2-(5-(2-(4-methoxyphenyl)-1-ethenyl)-2,4-dimethyl-3-thienyl)-3,3,4,4,5,5-hexafluorocyclopentene, 1-(6-(4-(4-methoxyphenyl)-1,3-butadienyl)-2-methyl-3-benzothienyl)-2-(5-(2-(4-methoxyphenyl)-1-ethenyl)-2,4-dimethyl-3-thienyl)-3,3,4,4,5,5-hexafluorocyclopentene, 1-(6-(2-(4-methoxyphenyl)-1-ethenyl)-2-methyl-3-benzothienyl)-2-(2,4-dimethyl-(5-(4-(4-methoxyphenyl)-1,3-butadienyl)-3-thienyl)-3,3,4,4,5,5-hexafluorocyclopentene, 1-(1,2-dimethyl-3-indolyl)-2-(2-cyano-3-methoxy-5-methylthienyl)-3,3,4,4,5,5-hexafluorocyclopentene, 1,2-bis(2-methyl-5-phenyl-3-thienyl)-3,3,4,4,5,5-hexafluorocyclopentene, 1,2-bis(2,4-dimethyl-5-phenyl-3-thienyl)-3,3,4,4,5,5-hexafluorocyclopentene, 1,2-bis(2-phenyl-5-methyl-4-thiazoyl)-3,3,4,4,5,5-hexafluorocyclopentene, 1,2-bis(2-methylbenzothiophen-3-yl)-3,3,4,4,5,5-hexafluorocyclopentene, 1,2-bis(3-methylbenzothiophen-2-yl)-3,3,4,4,5,5-hexafluorocyclopentene, 1,2-bis(3-methyl-2-thienyl)-3,3,4,4,5,5-hexafluorocyclopentene, 1,2-bis(2-methyl-6-nitro-3-benzothienyl)-3,3,4,4,5,5-hexafluorocyclopentene, 1-(3-methyl-2-thienyl)-2-(2-methyl-3-thienyl)-3,3,4,4,5,5-hexafluorocyclopentene, 1,2-bis(5-(4-methylphenyl)-2-methyl-3-thienyl)-3,3,4,4,5,5-hexafluorocyclopentene, 1-(2,4-dimethyl-5-phenyl-3-thienyl)-2-(2-methyl-5-phenyl-3-thienyl)-3,3,4,4,5,5-hexafluorocyclopentene, 1,2-bis(2,4-dimethyl-5-(4-methoxyphenyl)-3-thienyl)-3,3,4,4,5,5-hexafluorocyclopentene, 1-(2-methyl-5-(4-methylphenyl)-3-thienyl)-2-(2,4-dimethyl-5-(4-methylphenyl)-3-thienyl)-3,3,4,4,5,5-hexafluorocyclopentene, 1-(2-methyl-5-(4-methoxyphenyl)-3-thienyl)-2-(2,4-dimethyl-5-(4-methoxyphenyl)-3-thienyl)-3,3,4,4,5,5-hexafluorocyclopentene, 1-(3-methyl-2-thienyl)-2-(5-methyl-2-phenyl-4-thiazoyl)-3,3,4,4,5,5-hexafluorocyclopentene, 1-(3-methylbenzothiophen-2-yl)-2-(5-methyl-2-phenyl-4-thiazoyl)-3,3,4,4,5,5-hexafluorocyclopentene, 1-(2-methylbenzothiophen-3-yl)-2-(5-methyl-2-phenyl-4-thiazoyl)-3,3,4,4,5,5-hexafluorocyclopentene, 1-(2-methyl-5-methyl-benzothiophen-3-yl)-2-(5-methyl-2-phenyl-4-thiazoyl) -3,3,4,4,5,5-hexafluorocyclopentene, 1-(2-methyl-5-phenyl-benzothiophen-3-yl)-2-(5-methyl-2-phenyl-4-thiazoyl)-3,3,4,4,5,5-hexafluorocyclopentene, 1-(3-methyl-5-methyl-benzothiophen-2-yl)-2-(5-methyl-2-phenyl-4-thiazoyl)-3,3,4,4,5,5-hexafluorocyclopentene, 1-(3-methyl-5-phenyl-benzothiophen-2-yl)-2-(5-methyl -2-phenyl-4-thiazoyl)-3,3,4,4,5,5-hexafluorocyclopentene, 1-(3-methyl-6-methyl-benzothiophen-2-yl)-2-(5-methyl-2-phenyl-4-thiazoyl)-3,3,4,4,5,5-hexafluorocyclopentene, 1-(3-methyl-6-phenyl-benzothiophen-2-yl)-2-(5-methyl-2-phenyl-4-thiazoyl)-3,3,4,4,5,5-hexafluorocyclopentene, 1-(2-methyl-6-methyl-benzothiophen-3-yl)-2-(5-methyl-2-phenyl-4-thiazoyl)-3,3,4,4,5,5-hexafluorocyclopentene, 1-(2-methyl-6-phenyl-benzothiophen-3-yl)-2-(5-methyl-2-phenyl-4-thiazoyl)-3,3,4,4,5,5-hexafluorocyclopentene and the like can be exemplified.

Further illustrating the compounds represented by the aforementioned formula (5) or (6), as a maleic acid compound, dimethyl 2,3-di(2-methylbenzothienyl)-maleate and the like can be exemplified.

As a dicyanoethylene compound, 1,2-bis(2,3,5-trimethyl-4-thienyl)-1,2-dicyanoethylene, 1,2-bis(2-methyl-3-benzothienyl)-1,2-dicyanoethylene and the like can be exemplified.

The aforementioned diarylethene photochromic compound can be subjected to practical use as its direct dye form, as a resin powder particle containing the aforementioned compound or as a microcapsule pigment in which the aforementioned compound is encapsulated in a microcapsule. A color-memorizing photochromic ink composition suitable for a writing instrument in a different form is prepared by blending the compound in a water-based or oil-based vehicle, and a color-memorizing photochromic writing instrument is formed by accommodating the ink composition therein.

The aforementioned microcapsule pigment can be obtained by an appropriate method such as a conventionally known interfacial polymerization, in situ polymerization, submerged interfacial polymerization or spray drying, and those having a particle diameter of approximately from 0.5 to 50 μm, preferably from 1 to 30 μm, are effective in terms of dispersibility, durability and workability.

The content of the aforementioned diarylethene photochromic compound within the range from 0.5 to 50% by weight, preferably from 1 to 40% by weight in the ink can be subjected to practical use and satisfies a visual effect.

When the content is less than 0.5% by weight, a visual effect of a photochromic reaction is not satisfied due to low coloring concentration. On the other hand, even if the content is more than 50% by weight, it is difficult to obtain the coloring concentration effect corresponding to the content.

In this connection, by allowing the ink to contain a non-photochromic dye or pigment, the color can be changed from color (1) to another color (2).

Further, by applying a metallic luster pigment as the aforementioned pigment, particularly in a system of discoloring from colorless to colored, luster appearance is imparted to a colorless handwriting thereby giving it a distinguishing property, and luster feeling can be imparted to a colored handwriting.

The aforementioned metallic luster pigment is illustrated below.

Examples of the metallic luster pigment include aluminum powder, tin powder, lead powder, zinc powder, stainless steel powder, nickel powder, iron powder, copper powder, copper alloy powder, tin/lead/zinc/solder powder, brass powder, gold powder and silver powder, those obtained by coating the surface of natural mica, a synthetic mica, glass or alumina as a core material with a metal oxide such as titanium, zirconium, chromium, vanadium or iron, those obtained by finely powdering a multilayer film, those obtained by finely powdering a transparent film on which aluminum is deposited, those obtained by finely powdering a hologram film on which aluminum is deposited, those which are cholesteric liquid crystal type and the like.

As the metallic luster pigment containing natural mica as a core material, those obtained by coating the surface of natural mica with a metal oxide mainly composed of a titanium oxide and/or an iron oxide with an average thickness of from 0.1 to 5 μm and with an average particle diameter of from 2 to 300 μm are effective.

The pigment exhibits gold, silver or a metallic color depending on the coverage of the metal oxide. In this connection, the average particle diameter indicates an average particle diameter measured by laser diffraction analysis and is a particle diameter corresponding to 50% of the cumulative distribution of the median diameter on a volume basis.

Specific examples of the metallic luster pigment obtained by coating the surface of natural mica with a metal oxide include “Iriodin” (trade name) manufactured by Merck Co., stock number: 100 (10 to 60 μm: silver), 103 (10 to 50 μm: silver), 111 (15 μm or less: silver), 120 (5 to 20 μm: silver), 151 (5 to 100 μm: silver), 153 (30 to 100 μm: silver), 163 (40 to 200 μm: silver), 201 (5 to 50 μm: gold), 205 (10 to 60 μm: gold), 249 (10 to 100 μm: gold), 215 (10 to 60 μm: red-violet), 217 (10 to 60 μm: red-copper) 219 (10 to 60 μm: violet), 225 (10 to 60 μm: blue), 235 (10 to 60 μm: green), 300 (10 to 60 μm: gold), 302 (5 to 20 μm: gold), 320 (10 to 60 μm: gold), 351 (5 to 100 μm: gold), 355 (30 to 100 μm: gold), 500 (10 to 60 μm: gold), 504 (10 to 60 μm: red-gold), 520 (5 to 20 μm: gold) and 530 (10 to 100 μm: gold); “Mearlin” (trade name) manufactured by Engelhard Co., stock number: Magna Pearl 3000 (2 to 10 μm: silver), Satin White 9130F (4 to 32 μm: silver), Super White 9020C (6 to 48 μm: silver), Magna Pearl 1000 (8 to 48 μm: silver), Sparkle 9110P (10 to 110 μm: silver), Super Sparkle 9110S (10 to 150 μm: silver), Hilite Super Gold 9230Z (6 to 48 μm: gold), Hilite Super Red 9430Z (6 to 48 μm: red), Hilite Super Green 9830Z (6 to 48 μm: green), Hilite Super Orange 9330Z (6 to 48 μm: orange), Hilite Super Violet 9530Z (6 to 48 μm: violet) and Hilite Super Blue 9630Z (6 to 48 μm: blue); “LUMINA” (trade name) manufactured by Engelhard Co., stock number: GOLD (10 to 48 am: gold), RED (10 to 48 μm: red), RED-BLUE (10 to 48 μm: violet), AQUA-BLUE (10 to 48 μm: blue), TURQUOISE (10 to 48 μm: blue-green) and GREEN (10 to 48 μm: green) and the like.

Incidentally, the information in the parentheses in the stock numbers indicates the average particle diameter and the color of each pigment.

As the metallic luster pigment containing a synthetic mica as a core material, those obtained by coating the surface of a synthetic mica with a metal oxide mainly composed of a titanium oxide and/or an iron oxide with an average thickness of from 0.1 to 5 μm and with an average particle diameter of from 2 to 300 μm are effective. The pigment exhibits gold, silver or a metallic color depending on the coverage of the metal oxide. In this connection, the average particle diameter indicates an average particle diameter measured by laser diffraction analysis and is a particle diameter corresponding to 50% of the cumulative distribution of the median diameter on a volume basis.

Specific examples of the metallic luster pigment obtained by coating the surface of a synthetic mica with a metal oxide include “Ultimica” (trade name) manufactured by Nihon Koken Kogyo Co., stock number: SB-100 (5 to 30 μm: silver), SD-100 (10 to 60 μm: silver) SE-100 (15 to 100 μm: silver), SF-100 (44 to 150 μm: silver), SH-100 (150 to 600 μm: silver), YB-100 (5 to 30 μm: gold), YD-100 (10 to 60 μm: gold), YE-100 (15. to 100 μm: gold), YF-100 (44 to 150 μm: gold), RB-100 (5 to 30 μm: red), RD-100 (10 to 60 μm: red), RE-100 (15 to 100 μm: red), RF-100 (44 to 150 μm: red), RBB-100 (5 to 30 μm: red-violet), RBD-100 (10 to 60 μm: red-violet), RBE-100 (15 to 100 μm: red-violet), RBF-100 (44 to 150 μm: red-violet), VB-100 (5 to 30 μm: violet), VD-100 (10 to 60 μm: violet), VE-100 (15 to 100 μm: violet), VF-100 (44 to 150 μm: violet), BB-100 (5 to 30 μm: blue), BD-100 (10 to 60 μm: blue), BE-100 (15 to 100 μm: blue), BF-100 (44 to 150 μm: blue), GB-100 (5 to 30 μm: green), GD-100 (10 to 60 μm: green), GE-100 (15 to 100 μm: green), GF-100 (44 to 150 μm: green) and the like.

As the metallic luster pigment containing a flat glass piece as a core material, those obtained by coating the surface of a flat glass piece with a metal mainly composed of a titanium oxide, gold, silver nickel and an iron oxide with an average thickness of from 0.1 to 5 μm and with an average particle diameter of from 2 to 300 μm are effective. In this connection, the average particle diameter indicates an average particle diameter measured by laser diffraction analysis and is a particle diameter corresponding to 50% of the cumulative distribution of the median diameter on a volume basis.

Specific examples of the metallic luster pigment obtained by coating the surface of a flat glass piece with a metal include “Metashine” (trade name) manufactured by Nippon Sheet Glass Co., stock number: MC548OPS (480 μm: silver), MC5230PS (230 μm: silver), MC5150PS (150 μm: silver), MC509OPS (90 μm: silver), MC5030PS (30 μm: silver), MC208OPS (80 μm: silver), ME204OPS (40 μm: silver), ME2015PS (15 μm: silver), ME2025PSS1 (25 μm: silver), MC509OPSS1 (90 μm: silver), MC509OPSS2 (90 μm: silver), MC2015PSW1 (15 μm: silver), MC2025PSD1 (25 μm: silver), MC548ONS (480 μm: silver) MC5140NS (140 μm: silver), MC5090NS (90 μm: silver), MC503ONS (30 μm: silver), MC548ONB (480 μm: silver), MC5090NB (90 μm: silver), MC503ONB (480 μm: silver), MC108ONB (80 μm: silver), MC102ONB (20 μm: silver), MC509ORS (90 μm: silver), MC509ORY (90 μm: gold), MC509ORR (90 μm: red), MC509ORV (90 μm: violet) , MC509ORB (90 μm: blue), MC509ORG (90 μm: green), MC108ORS (80 μm: silver), MC108ORY (80 μm: gold), MC108ORR (80 μm: red), MC108ORB (80 μm: blue), MC108ORG (80 μm: green), MC104ORS (40 μm: silver), MC104ORY (40 μm: gold), MC104ORR (40 μm: red), MC104ORB (40 μm: blue), MC104ORG (40 μm: green) MC102ORS (20 μm: silver), MC102ORY (20 μm: gold), MC102ORR (20 μm: red), MC102ORB (20 μm: blue), MC102ORG (20 μm: green), MC108ORSS1 (80 μm: silver), MC108ORYS1 (80 μm: gold) and the like.

As a metallic luster pigment containing a thin aluminum oxide as a core material, those obtained by coating the surface of a thin aluminum oxide with a metal oxide mainly composed of a titanium oxide and/or an iron oxide with an average thickness of from 0.1 to 5 μm and with an average particle diameter of from 2 to 100 μm are effective. The pigment exhibits gold, silver or a metallic color depending on the coverage of the metal oxide. In this connection, the average particle diameter indicates an average particle diameter measured by laser diffraction analysis and is a particle diameter corresponding to 50% of the cumulative distribution of the median diameter on a volume basis.

Specific examples of the metallic luster pigment obtained by coating the surface of a thin aluminum oxide with a metal oxide include “Xirallic” (trade name) manufactured by Merck Co., stock number: T60-1OWNT (10 to 30 μm: silver), T60-20WNT (10 to 30 μm: gold), T60-21WNT (10 to 30 μm: red), F60-50WNT (10 to 30 μm: copper), F60-51WNT (10 to 30 μm: red), T50-10 (10 to 30 μm: silver) and the like.

As a multilayer metallic luster pigment containing thin aluminum as a core material, those obtained by coating the surface of thin aluminum with a silicon oxide and further coating it with a metal oxide mainly composed of an iron oxide with an average thickness of from 0.1 to 5 μm and with an average particle diameter of from 2 to 100 μm are effective. In this connection, the average particle diameter indicates an average particle diameter measured by laser diffraction analysis and is a particle diameter corresponding to 50% of the cumulative distribution of the median diameter on a volume basis.

Specific examples of such a metallic luster pigment obtained by coating the surface of thin aluminum with a multilayer metal oxide include “VARIOCROM” (trade name) manufactured by BASF Co., stock number: MAGIC RED L4420 (10 to 30 μm: red).

As a multilayer metallic luster pigment containing a thin iron oxide as a core material, those obtained by coating the surface of a thin iron oxide with a silicon oxide and further coating it with a metal oxide mainly composed of an iron oxide with an average thickness of from 0.1 to 5 μm and with an average particle diameter of from 2 to 100 μm are effective. In this connection, the average particle diameter indicates an average particle diameter measured by laser diffraction analysis and is a particle diameter corresponding to 50% of the cumulative distribution of the median diameter on a volume basis.

Specific examples of such a metallic luster pigment obtained by coating the surface of a thin iron oxide with a multilayer metal oxide include “VARIOCROM” (trade name) manufactured by BASF Co., stock number: MAGIC PURPLE L5520 (10 to 30 μm: purple).

As a metallic luster pigment containing thin aluminum as a core material, those obtained by coating the surface of thin aluminum with a metal oxide mainly composed of an iron oxide with an average thickness of from 0.1 to 5 μm and with an average particle diameter of from 2 to 100 μm are effective. In this connection, the average particle diameter indicates an average particle diameter measured by laser diffraction analysis and is a particle diameter corresponding to 50% of the cumulative distribution of the median diameter on a volume basis.

Specific examples of such a metallic luster pigment obtained by coating the surface of thin aluminum with a metal oxide include “PALIOCROM” (trade name) manufactured by BASF Co., stock number: GOLD L2000 (10 to 30 μm: gold), GOLD L2020 (10 to 30 μm: gold), GOLD L2025 (10 to 30 μm: gold) and the like.

As a metallic luster pigment containing a thin iron oxide as a core material, those obtained by coating the surface of a thin iron oxide with a metal mainly composed of aluminum and manganease with an average thickness of from 0.1 to 5 μm and with an average particle diameter of from 2 to 100 μm are effective. In this connection, the average particle diameter indicates an average particle diameter measured by laser diffraction analysis and is a particle diameter corresponding to 50% of the cumulative distribution of the median diameter on a volume basis.

Specific examples of such a metallic luster pigment obtained by coating the surface of thin aluminum with a metal oxide include “PALIOCROM” (trade name) manufactured by BASF Co., stock number: COPPER L3000 (10 to 30 μm: gold-red), COPPER L3101 (10 to 30 μm: gold-red) and the like.

The cholesteric liquid crystal metallic luster pigment has a characteristic of reflecting only a certain range of the incident light having a broad spectral range by the light interference effect of a liquid crystal polymer to be used and transmitting all the light other than this range. The reflectance spectral range depends on the pitch width of a helical polymer and the refractive index of a material, and the reflectance spectral range is split into left and right circularly polarized light components. At this time, according to the rotation direction of helix, it becomes possible that one component is reflected and the other component is transmitted. In this way, it has a characteristic of transmission and reflection over the whole spectral range, in other words, an excellent metallic luster property and a color flop effect in which color changes depending on the view angle.

Specific examples of the cholesteric liquid crystal metallic luster pigment include “Helicone HC” (trade name) manufactured by Wacker-Chemie Co., stock number: Sapphire (SLM90020) (blue to dark color), Scarabeus (SLM90120) (green to blue), Jade (SLM90220) (gold to green-blue), Maple (SLM90320) (red-copper to green) and the like.

In order to form a handwriting with a concentration of high visible sense by effectively expressing the coloring property of the aforementioned diarylethene photochromic compound as a photochromic agent, it is effective that the vehicle satisfies the following requirements.

The vehicle has a light reflectance of a dry coating film in the wavelength range from 350 nm to 400 nm according to the following measurement method of 20% or more. In a system in which an emulsion binder is employed and the binder itself is in an undissolved state in the solvent, the reflectance is preferably 30% or more, and in a system in which the binder is in a dissolved state in the vehicle, the reflectance is more preferably 40% or more.

As for the measurement method, a specimen vehicle is coated on a white synthetic paper (a polyolefin synthetic paper in which a white pigment is blended) at a thickness of about 50 nm using a bar coater, dried at normal temperature to form a dry film, which is used as a specimen for measurement, and the aforementioned white synthetic paper is used as a reference specimen, and the reflectance in the wavelength range from 350 nm to 400 nm is obtained using a spectrophotometer (self-recording spectrophotometer U-3210, manufactured by Hitachi).

When the light reflectance of the vehicle is less than 20%, the effective expression of the ultraviolet ray irradiation effect on the photochromic agent is inhibited, and the effect on visualization by effectively expressing the original coloring concentration of the photochromic agent is poor.

Therefore, as for the binder resin or various additives constituting the vehicle, those which do not have an ultraviolet ray absorbency or even if they have an ultraviolet ray absorbency, those which do not inhibit the aforementioned reflectance effect are employed.

Incidentally, a photostabilizer such as an ultraviolet ray absorbent can also be added to the vehicle if it does not inhibit the aforementioned reflectance effect.

As the binder resin constituting the vehicle that satisfies the aforementioned requirements, a variety of synthetic resin emulsions such as aqueous dispersions of polyacrylic acid esters, styrene-acrylate copolymers, polyvinyl acetate, ethylene-vinyl acetate copolymers, ethylene methacrylic acid copolymers, α-olefin-maleic acid copolymers, silicone resins, polyester and polyurethane; water-soluble resins such as polyvinyl alcohols, polyvinyl pyrrolidone and polyvinyl butyral; alkali-soluble resins such as styrene-maleic acid copolymers, ethylene-maleic acid copolymers and styrene- acrylate copolymers; oil-soluble resins such as ketone resins, ketone-formaldehyde resins, amide resins, alkyd resins, rosin-modified resins, rosin-modified phenol resins, phenol resins, xylene resins, polyvinyl pyrrolidone, α- and β-pinene-phenol polycondensation resins, polyvinyl butyral resins and acrylic resins can be exemplified. Other than these, as adhesion agents selected from glue agents and the like or a variety of additives, for example, glycols such as glycerin, propylene glycol, ethylene glycol, diethylene glycol and low molecular weight polyethylene glycols, and lower alkyl ethers thereof, moisturizing agents for suppressing dryness such as 2-pyrrolidone, N-vinyl pyrrolidone and urea can be blended in an appropriate amount.

Further, shear-thinning materials, for example, those selected from nonionic surfactants having a specific HLB value, xanthan gum, welan gum, succinoglycan (organic acid-modified heteroglycan composed of glucose unit and galactose unit, having an average molecular weight of from about 100 to 8,000, 000), guar gum, locust bean gum or derivatives thereof, hydroxyethyl cellulose, alkyl alginates, polymers mainly composed of alkyl methacrylate and having a molecular weight of from 100, 000 to 150, 000, glycomannan, hydrocarbons having a gelling ability and extracted from seaweed such as agar or carrageenan, benzylidenesorbitol or derivatives thereof, crosslinking acrylic acid polymers and the like, are used alone or mixed in combination, and a shear-thinning ink with a viscosity of from 40 to 160 mPa·s (the value measured at a rotation rate of 100 rpm and at 25° C. using an EMD rotating viscometer) is prepared, whereby due to the shearing force on the writing tip during writing, for example in the form of a ballpoint pen, a high shearing force caused by high-speed rotation of the ball during writing, the viscosity of the ink in the vicinity of the ball is lowered, and the ink is allowed to flow out smoothly.

Further, by employing a polymeric flocculating agent such as polyvinylpyrrolidone, polyethylene oxide, a water-soluble polysaccharide or a nonionic water-soluble cellulose derivative, a cohesive ink with a viscosity of from 3 to 20 mPa·s (25° C.) can be prepared. Therefore, by a mild crosslinking effect of the aforementioned water-soluble polymeric flocculating agent, an ink in which pigments in the form of mildly cohesive microcapsules or resin powder particles are in a suspended state is allowed to flow out from the writing tip while stably maintaining the suspended state in a member having capillary spaces for a long time without being destroyed.

Examples of the water-soluble polysaccharides include tragacanth gum, guar gum, pullulan, cyclodextrin and the like. Examples of the nonionic water-soluble cellulose derivative include methyl cellulose, hydroxy cellulose, hydroxyethyl cellulose, hydroxypropyl cellulose, hydroxyethyl methyl cellulose, hydroxypropyl methyl cellulose and the like.

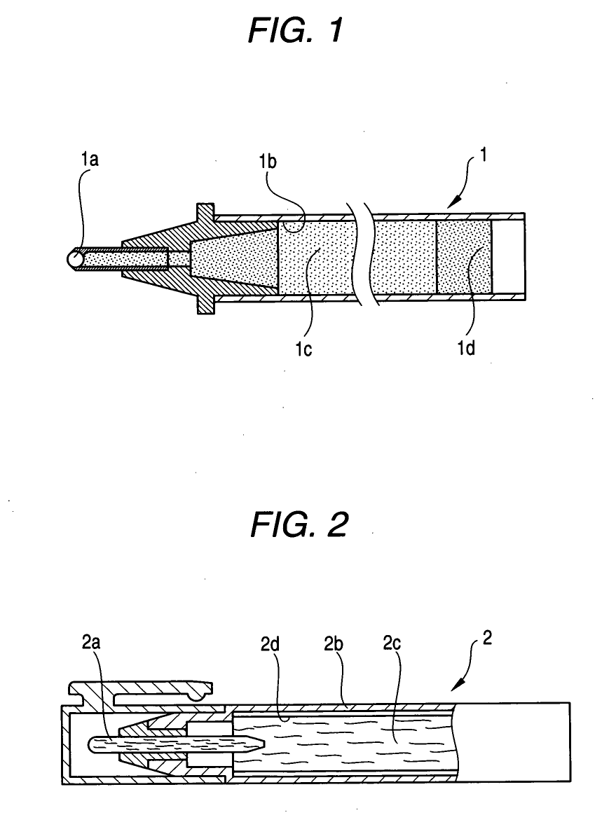

A tubular member provided with a tip rotatably holding a ball at the front end portion is filled with a shear-thinning ink in which the aforementioned shear-thinning material is blended, and an ink follower (liquid stopper) is disposed at the rear portion, whereby a color-memorizing photochromic writing instrument in the form of a ballpoint pen can be constituted (see FIG. 1).

In addition, a fiber bundle in which capillary spaces are formed between adjacent fibers is impregnated with a cohesive ink in which a polymeric flocculating agent is blended, and is accommodated in a tubular member, whereby a color-memorizing photochromic writing instrument in the form of a marking pen provided with a pen body at the front end portion can be constituted (see FIG. 2).

A high viscous oil-based ink having a viscosity of from about 10,000 to 20,000 mPa·s can be applied to a conventional all-purpose oil-based ballpoint pen mechanism. A low viscous water-based ink having a viscosity of from about 1 to 15 mPa·s can be applied to a writing instrument mechanism having a mechanism in which an ink-adjusting member for temporarily retaining spilled ink according to the increase in internal pressure in the ink tank is disposed between the ballpoint pen tip and the ink tank, or a front end portion mechanism in which an ink through hole communicating to the ball is provided in the axial core of the ballpoint pen tip and the outer periphery of the ball is brought into close contact with the front end portion of the inner wall of a ball holding portion by disposing, in the ink through hole, a resilient member for resiliently pressing the back face of the ball toward the front end of the ballpoint pen.

A handwriting formed with the aforementioned color-memorizing photochromic writing instrument is allowed to develop color by irradiation with ultraviolet rays using an ultraviolet irradiator or sunlight containing ultraviolet rays thereby immediately being discolored from colorless to colored or from color (1) to another color (2) and maintained in the discolored state even if it is left in a condition where ultraviolet rays are not irradiated thereby being recognized visually, and can be returned to the original state (colorless or color (1)) as needed by irradiating the handwriting with visible light, and can be visualized by memorizing and maintaining the state.

### EXAMPLES

An ink composition for a color-memorizing photochromic writing instrument of the present invention is not limited to the following Examples, can be applied to any form of a writing instrument according to the intended purpose, has an ink property applicable to the aforementioned form of a writing instrument, and can be subjected to practical use.

Incidentally, all parts in the Examples are parts by weight.

In addition, the shear-thinning index (n) in the Examples is expressed as a value n calculated by fitting a shear stress value (T) and a shear rate value (J) obtained from rheological measurements on a viscometer to an experimental equation (T=KJⁿ, in which K is calculated constants).

### Example 1

Preparation of Ink for Color-memorizing Photochromic Writing Instrument

A shear-thinning color-memorizing photochromic ink comprising 44.0 parts of microcapsule slurry (solid content: 27.3%) of a microcapsule pigment (average particle diameter: 2.5 μm) in which a diarylethene photochromic compound A (1,2-bis(2,4-dimethyl-5-phenyl-3-thienyl)-3,3,4,4,5,5-hexafluorocyclopentene) which reversibly changes color from colorless to blue was encapsulated with an epoxy resin film by a known interfacial polymerization method, 0.33 part of xanthan gum (a shear-thinning material), 32.86 parts of water, 11.0 parts of urea, 11.0 parts of glycerin, 0.55 part of a nonionic permeability imparting agent (trade name: Nopco SW-WET-366, manufactured by San Nopco Co.), 0.13 part of a modified silicone defoamer (trade name: Nopco 8034, manufactured by San Nopco Co.) and 0.13 part of a fungicide (trade name: Proxel XL-2, manufactured by Zeneca Co.) was prepared.

As a result of measuring the viscosity of the ink at 25° C. with an EMD viscometer, it was 1020 mPa·s at a measuring rotation rate of 1 rpm, and 84 mPa·s at a measuring rotation rate of 100 rpm, and the shear-thinning index n was 0.48. In addition, the light reflectance of the film of the vehicle having the same composition as that of the aforementioned ink except that the microcapsule slurry was omitted was 97% at 400 nm and 90% at 350 nm. Production of color-memorizing photochromic writing instrument The aforementioned ink was filled by suction at 0.8 g in a polypropylene pipe with an inner diameter of 3.3 mm, which was connected to a ballpoint pen tip via a resin holder.

Incidentally, as the aforementioned ballpoint pen tip, acutting-type ballpoint pen tip in which a stainless steel ball with a size of 0.8 mm was accommodated (a moving distance in a radial direction of the ball is about 20 μm and a movable distance in an axial direction is about 70 am) was used.

Subsequently, an ink follower (liquid stopper) having viscoelasticity based on polybutene was injected from the tail portion of the aforementioned polypropylene pipe, a tubular member, a cap, a mouth ring and a tail stopper were installed, and then a degassing treatment was carried out by centrifugation, whereby a color-memorizing photochromic ballpoint pen was obtained.

Color-changing Behavior of Handwriting

When writing was carried out on a writing paper with the aforementioned ballpoint pen and the handwriting was irradiated with sunlight, the handwriting was discolored from colorless to blue by ultraviolet rays contained in sunlight. This state was maintained without discoloring when it was left outside, in a room or in a dark place.

### Example 2

Preparation of Ink for Color-memorizing Photochromic Writing Instrument

44.0 parts of slurry (solid content: 30%) of a color-memorizing photochromic pigment obtained by dissolving a diarylethene photochromic compound B (1,2-bis(5-methyl-2-phenyl-4-thiazoyl)-3,3,4,4,5,5-hexafluorocyclopentene) which reversibly changes color from colorless to pink in a styrene resin and xylene and allowing it to have an average particle diameter of 2 μm in water with an agitator and then removing xylene from the emulsion by heating was homogenously dispersed in an aqueous medium comprising 5.0 parts of glycerin, 0.7 part of a fungicide (trade name: Proxel XL-2, manufactured by Zeneca Co.), 0.1 part of a silicone defoamer (trade name: SN defoamer 381, manufactured by San Nopco Co.) and 42.2 parts of water, and 8.0 parts of an aqueous solution containing 5.0% by weight of hydroxyethyl cellulose (a water-soluble polymeric flocculating agent, trade name: Cellulosize WP-09L, manufactured by Union Carbide Japan KK.) was added to the solution in a dispersed state while stirring, whereby a cohesive ink for a color-memorizing photochromic writing instrument in which the color-memorizing photochromic pigment was suspended in a mild cohesive state was prepared.

As a result of measuring the viscosity of the ink at 25° C. with a B-type viscometer by applying a BL adapter, it was 4.4 mPa·s at a measuring rotation rate of 60 rpm. In addition, the light reflectance of the film of the vehicle having the same composition as that of the aforementioned cohesive ink for the color-memorizing photochromic writing instrument except that the color-memorizing photochromic pigment was omitted was 95% at 400 nm and 85% at 350 nm.

Production of Color-memorizing Photochromic Writing Instrument

A fiber bundle ink absorber (porosity: about 80%) obtained by coating polyester sliver with a synthetic resin film was impregnated with the ink right after the ink was stirred into a homogenous mixture, accommodated in a tubular member, and installed in a contacted state with a processed resin pen body made of a polyester fiber (porosity: about 50%) attached to the front end portion of the tubular member, whereby a color-memorizing photochromic marking pen was obtained.

Color-changing Behavior of Handwriting

When writing was carried out on a writing paper with the aforementioned marking pen and the handwriting was irradiated with sunlight; the handwriting was discolored from colorless to pink by ultraviolet rays contained in sunlight. This state was maintained without discoloring when it was left outside, in a room or in a dark place.

### Example 3

Preparation of Ink for Color-memorizing Photochromic Writing Instrument

A shear-thinning ink for a color-memorizing photochromic writing instrument comprising 44.0 parts of microcapsule slurry (solid content: 30%) of a microcapsule pigment (average particle diameter: 2.5 μm) in which a diarylethene photochromic compound C (1,2-bis(3-methyl-2-thienyl)-3,3,4,4,5,5-hexafluorocyclopentene) which reversibly changes color from colorless to yellow was encapsulated with an epoxy resin film by a known interfacial polymerization method, 1 part of a silver metallic luster pigment (trade name: Iriodin 111, manufactured by Merck Co.), 0.33 part of xanthan gum (a shear-thinning material), 31.86 parts of water, 11.0 parts of urea, 11.0 parts of glycerin, 0.55 part of a nonionic permeability imparting agent (trade name: Nopco SW-WET-366, manufactured by San Nopco Co.), 0.13 part of a modified silicone defoamer (trade name: Nopco 8034, manufactured by San Nopco Co.) and 0.13 part of a fungicide (trade name: Proxel XL-2, manufactured by Zeneca Co.) was prepared.

As a result of measuring the viscosity of the ink at 25° C. with an EMD viscometer, it was 1020 mPa·s at a measuring rotation rate of 1 rpm, and 84 mPa·s at a measuring rotation rate of 100 rpm, and the shear-thinning index n was 0.48. In addition, the light reflectance of the film of the vehicle having the same composition as that of the aforementioned ink except that the microcapsule slurry was omitted was 55% at 400 nm and 40% at 350 nm.

Production of Color-memorizing Photochromic Writing Instrument

A ballpoint pen refill in which a stainless steel tip holding a ball with a diameter of 0.7 mm was fitted and attached to one end of a polypropylene pipe was filled with the aforementioned ink, and further an ink follower was injected at the rear end of the ink. Then, the ballpoint pen refill was installed in a tubular member, whereby a color-memorizing photochromic ballpoint pen was obtained.

When writing was carried out on a writing paper with the aforementioned ballpoint pen, a light silver handwriting was obtained.

Color-changing Behavior of Handwriting

An ultraviolet ray lamp and a light source were installed in the inside of the plastic main body, and ultraviolet rays were irradiated from an ultraviolet irradiator capable of irradiating the handwriting with ultraviolet rays from the front end portion by pressing the switch. As a result, the handwriting was changed from light silver to gold. This state was maintained without discoloring when it was left outdoors, in a room or in a dark place.

### Example 4

Preparation of Ink for Color-memorizing Photochromic Writing Instrument and Production of Writing Instrument

13.0 parts of a color-memorizing photochromic pigment with an average particle diameter of 2 μm obtained by dissolving a diarylethene photochromic compound A (1,2-bis(2,4-dimethyl-5-phenyl-3-thienyl)-3,3,4,4,5,5-hexafluorocyclopentene) which reversibly changes color from colorless to blue in a styrene resin and subjecting it to a bulk resin grinding method was homogenously dispersed in an aqueous medium comprising 0.5 part of a red dye (Erythrosine, C.I. 4530, manufactured by Aizen-Hodogaya Co.), 5.0 parts of glycerin, 0.7 part of a fungicide (trade name: Proxel XL-2, manufactured by Zeneca Co.), 0.1 part of a silicone defoamer (trade name: SN defoamer 381, manufactured by San Nopco Co.) and 41.7 parts of water, and 8.0 parts of an aqueous solution containing 5.0% by weight of hydroxyethyl cellulose (a water-soluble polymeric flocculating agent, trade name: Cellulosize WP-09L, manufactured by Union Carbide Japan KK.) was added to the solution in a dispersed state while stirring, whereby a cohesive ink for a color-memorizing photochromic writing instrument in which the color-memorizing photochromic pigment was suspended in a mild cohesive state was prepared.

As a result of measuring the viscosity of the ink at 25° C. with a B-type viscometer by applying a BL adapter, it was 4.4 mPa·s at a measuring rotation rate of 60 rpm. In addition, the light reflectance of the film of the vehicle having the same composition as that of the aforementioned ink except that the color-memorizing photochromic pigment was omitted was 45% at 400 nm and 35% at 350 nm. By using the aforementioned ink, a color-memorizing photochromic marking pen was obtained in the same manner as in Example 2.

When writing was carried out on a writing paper with the aforementioned marking pen, a clear pink handwriting was obtained without forming a handwriting with color shades even when writing was carried out for a long time or writing in shorthand was carried out.

Color-changing Behavior of Handwriting

When the aforementioned handwriting was irradiated with sunlight, the handwriting was discolored from pink to purple by ultraviolet rays contained in sunlight. This state was maintained without discoloring when it was left outside, in a room or in a dark place.

### Example 5

Preparation of Ink for Color-memorizing Photochromic Writing Instrument

An ink for a color-memorizing photochromic writing instrument was prepared by stirring and mixing 3 parts of a diarylethene photochromic compound D (1-(2-phenyl-5-methyl-4-thiazoyl)-2-(3-methyl-2-thienyl)-3,3,4,4,5,5-hexafluorocyclopentene) which reversibly changes color from colorless to orange, 7 parts of a ketone-formaldehyde resin (trade name: Synthetic Resin SK, manufactured by Huels Co.), 78 parts of propylene glycol monomethyl ether and 10 parts of methyl lactate.

The light reflectance of the film of the vehicle having the same composition as that of the aforementioned ink for the color-memorizing photochromic writing instrument except that the diarylethene photochromic compound D was omitted was 90% at 400 nm and 80% at 350 nm.

Production of Color-memorizing Photochromic Writing Instrument

A color-memorizing photochromic marking pen was obtained by impregnating, with the ink, an ink absorber composed of a fiber bundle accommodated in the inside of a marking pen provided with a pen body composed of a processed resin article of fiber bundle having capillary tube ink passages at the front end portion of the tubular member.

Color-changing Behavior of Handwriting

When writing was carried out on a paper with the aforementioned marking pen and the handwriting was irradiated with sunlight, the handwriting was discolored from colorless to orange by ultraviolet rays contained in sunlight. This state was maintained without discoloring when it was left outside, in a room or in a dark place.

### Example 6

Preparation of Ink for Color-memorizing Photochromic Writing Instrument

An ink for color-memorizing photochromic writing instrument was prepared by stirring and mixing 4 parts of a diarylethene photochromic compound B (1,2-bis(5-methyl-2-phenyl-4-thiazoyl)-3,3,4,4,5,5-hexafluorocyclopentene) which reversibly changes color from colorless to pink, 0.1 part of a blue dye (Victoria Pure Blue BOH, C.I. basic blue 7, manufactured by Hodogaya Chemical Co.), 7 parts of a ketone-formaldehyde resin (trade name: Synthetic Resin SK, manufactured by Huels Co.), 78 parts of propylene glycol monomethyl ether and 10 parts of methyl lactate.

The light reflectance of the film of the vehicle having the same composition as that of the aforementioned ink for the color-memorizing photochromic writing instrument except that the diarylethene photochromic compound B was omitted was 60% at 400 nm and 50% at 350 nm.

Production of Color-memorizing Photochromic Writing Instrument

A color-memorizing photochromic marking pen was obtained by impregnating, with the ink, an ink absorber composed of a fiber bundle accommodated in the inside of a marking pen provided with a pen body composed of a processed resin article of fiber bundle having capillary tube ink passages at the front end portion of the tubular member.

When writing was carried out on a paper with the aforementioned marking pen, a clear blue handwriting was obtained without forming a handwriting with color shades even when writing was carried out for a long time or writing in shorthand was carried out.

Color-changing Behavior of Handwriting

When the aforementioned handwriting was irradiated with sunlight, the handwriting was discolored from blue to purple by ultraviolet rays contained in sunlight. This state was maintained without discoloring when it was left outside, in a room or in a dark place.

### Example 7

Preparation of Ink for color-memorizing Photochromic Writing Instrument

An ink for color-memorizing photochromic writing instrument was prepared by stirring and mixing 3 parts of a diarylethene photochromic compound E (1,2-bis(2-methyl-6-nitro-3-benzothienyl)-3,3,4,4,5,5-hexafluorocyclo- pentene) which reversibly changes color from colorless to green, 7 parts of a ketone-formaldehyde resin (trade name: Synthetic Resin SK, manufactured by Huels Co.), 10 parts of an acrylic copolymer emulsion (trade name: Primal ASE-60, Manufactured by Rohm & Haas Co.), 2 parts of polyoxyethylene alkyl ether phosphate (trade name: Plysurf A207H, manufactured by Daiichi Kogyo Seiyaku Co.), 5 parts of benzyl alcohol and 71 parts of ethyl alcohol.

The light reflectance of the film of the vehicle having the same composition as that of the aforementioned ink except that the diarylethene photochromic compound E was omitted was 96% at 400 nm and 80% at 350 nm.

Production of Color-memorizing Photochromic Writing Instrument

The aforementioned ink was filled in a ballpoint pen refill in which a stainless steel tip holding a ball with a diameter of 0.7 mm was fitted and attached to one end of a polypropylene pipe, and an ink follower was injected at the rear end of the ink. Then, the ballpoint pen refill was installed in a tubular member, whereby a color-memorizing photochromic ballpoint pen was obtained.

Color-changing Behavior of Handwriting When writing was carried out on a paper with the aforementioned ballpoint pen and the handwriting was irradiated with sunlight, the handwriting was discolored from colorless to green by ultraviolet rays contained in sunlight. This state was maintained without discoloring when it was left outside, in a room or in a dark place.

### Example 8

Preparation of Ink for Color-memorizing Photochromic Writing Instrument

An ink for color-memorizing photochromic writing instrument was prepared by stirring and mixing 3 parts of a diarylethene photochromic compound B (1,2-bis(5-methyl-2-phenyl-4-thiazoyl)-3,3,4,4,5,5-hexafluorocyclopentene) which reversibly changes color from colorless to pink, 0.1 part of a blue dye (Victoria Pure Blue BOH, C.I. basic blue 7, manufactured by Hodogaya Chemical Co.),7 parts of a ketone-formaldehyde resin (trade name: Synthetic Resin SK, manufactured by Huels Co.), 10 parts of an acrylic copolymer emulsion (trade name: Primal ASE-60, Manufactured by Rohm & Haas Co.), 2 parts of polyoxyethylene alkyl ether phosphate (trade name: Plysurf A207H, manufactured by Daiichi Kogyo Seiyaku Co.), 5 parts of benzyl alcohol and 71 parts of ethyl alcohol.

The light reflectance of the film of the vehicle having the same composition as that of the aforementioned ink except that the diarylethene photochromic compound B was omitted was 60% at 400 nm and 50% at 350 nm.

Production of Color-memorizing Photochromic Writing Instrument

The aforementioned ink was filled in a ballpoint pen refill in which a stainless steel tip holding a ball with a diameter of 0.7 mm was fitted and attached to one end of a polypropylene pipe, and an ink follower was injected at the rear end of the ink. Then, the ballpoint pen refill was installed in a tubular member, whereby a color-memorizing photochromic ballpoint pen was obtained.

When writing was carried out on a paper with the aforementioned ballpoint pen, a clear blue handwriting was obtained without forming a handwriting with color shades even when writing was carried out for a long time or writing in shorthand was carried out.

Color-changing Behavior of Handwriting

When the aforementioned handwriting was irradiated with sunlight, the handwriting was discolored from blue to purple by ultraviolet rays contained in sunlight. This state was maintained without discoloring when it was left outside, in a room or in a dark place.

### Example 9

Preparation of Ink for Color-memorizing Photochromic Writing Instrument

An ink for a color-memorizing photochromic writing instrument comprising 6.3 parts of microcapsule slurry (solid content: 27.3%) of a microcapsule pigment (average particle diameter: 2.5 μm) in which a diarylethene photochromic compound A (1,2-bis(2,4-dimethyl-5-phenyl-3-thienyl)-3,3,4,4,5,5-hexafluorocyclopentene) which reversibly changes color from colorless to blue was encapsulated with an epoxy resin film by a known interfacial polymerization method, 0.7 part of aluminum paste (trade name: 96-2104, manufactured by Toyo Aluminium KK.), 15.0 parts of glycerin, 0.3 part of succinoglycan (organic acid-modified heteroglycan composed of glucose unit and galactose unit), 0.3 part of sodium omadine (trade name: Topside 280, manufactured by Permachem Co.), 1.0 part of an amine salt of EDTA (trade name: Chelest M-50, manufactured by Chelest Co.), 3.0 parts of α-cyclodextrin (trade name: Dexy Pearl K-100, manufactured by Ensuiko Seito Co.), 0.3 part of triethanolamine and 73.3% water was prepared.

As a result of measuring the viscosity of the ink at 25° C. with an EMD viscometer, it was 1400 mPa·s at a measuring rotation rate of 1 rpm, and 44 mPa·s at a measuring rotation rate of 100 rpm, and the shear-thinning index n was 0.25. In addition, the light reflectance of the film of the vehicle having the same composition as that of the aforementioned ink except that the microcapsule slurry was omitted was 50% at 400 nm and 40% at 350 nm.

Production of Color-memorizing Photochromic Writing Instrument

The aforementioned ink was filled in a ballpoint pen refill in which a stainless steel tip holding a ball with a diameter of 0.7 mm was fitted and attached to one end of a polypropylene pipe, and an ink follower was injected at the rear end of the ink. Then, the ballpoint pen refill was installed in a tubular member, whereby a color-memorizing photochromic ballpoint pen was obtained.

When writing was carried out on a writing paper with the aforementioned ballpoint pen, a handwriting in which silver is sparsely observed was obtained without forming a handwriting with color shades even when writing was carried out for a long time or writing in shorthand was carried out.

Color-changing Behavior of Handwriting

When the aforementioned handwriting was irradiated with sunlight, the handwriting was changed from a state where silver was sparsely observed to a state where the handwriting was blue and silver was sparsely observed by ultraviolet rays contained in sunlight. This state was maintained without discoloring when it was left outside, in a room or in a dark place.

An ink composition of the present invention can give a handwriting which is allowed to develop color by irradiation with ultraviolet rays or sunlight containing ultraviolet rays, thereby being discolored in high sensitivity and high concentration from colorless to colored or in a system in which a non-photochromic dye or pigment is used in combination, from color (1) to another color (2) and memorized and maintained in the discolored state under normal conditions unless visible light is irradiated. In addition, in a system in which a luster pigment is used in combination, luster appearance is imparted to a colorless handwriting, whereby a distinguishing property can be given to it.

The aforementioned ink composition is accommodated in a tubular member, and a variety of forms of writing instruments are constituted so as to allow the ink composition to flow out from a writing tip portion. Accordingly, an arbitrary writing image can be formed, the usefulness as a convenient color-memorizing photochromic writing instrument provided with applicability in various fields such as application to felt-tip pens, toys, and also studying and information communication is satisfied.

While the invention has been described in detail and with reference to specific embodiments thereof, it will be apparent to one skilled in the art that various changes and modifications can be made therein without departing from the scope thereof.

This application is based on Japanese patent application No. 2003-74860 filed on Mar. 19, 2003 the entire contents thereof being hereby incorporated by reference.

What is claimed is:

1. An ink composition for a color-memorizing photochromic writing instrument, which comprises a photochromic agent containing a diarylethene photochromic compound dissolved, dispersed or suspended in a vehicle containing at least a solvent and a binder.

2. The ink composition for a color-memorizing photochromic writing instrument according to claim 1, wherein the vehicle has a light reflectance of a dry coating film in the wavelength range from 350 nm to 400 nm of 20% or more.

3. The ink composition for a color-memorizing photochromic writing instrument according to claim 1, wherein the photochromic agent is a microcapsule pigment in which the diarylethene photochromic compound is encapsulated or a resin powder particle containing the photochromic compound.

4. The ink composition for a color-memorizing photochromic writing instrument according to claim 1, which further comprises a non-photochromic dye or pigment.

5. The ink composition for a color-memorizing photochromic writing instrument according to claim 4, wherein the pigment is selected from a luster pigment.

6. The ink composition for a color-memorizing photochromic writing instrument according to claim 1, which further comprises a shear-thinning material thereby to have a shear-thinning property.

7. The ink composition for a color-memorizing photochromic writing instrument according to claim 1, which further comprises a water-soluble polymeric flocculating agent, wherein the microcapsule pigment in which the diarylethene photochromic compound is encapsulated or the resin powder particle containing the photochromic compound are suspended in a mildly cohesive state.

8. A color-memorizing photochromic writing instrument, which comprises an ink composition for a color-memorizing photochromic writing instrument according to any one of claims 1 to 7 contained in a tubular member, which is constituted so as to enable writing by allowing the ink composition to flow out from a writing tip portion.

9. The color-memorizing photochromic writing instrument according to claim 8, which is in the form of a ballpoint pen containing the ink composition for a color-memorizing photochromic writing instrument according to claim 6 in the tubular member.

10. The color-memorizing photochromic writing instrument according to claim 8, wherein the ink composition for a color-memorizing photochromic writing instrument according to claim 7 is contained in an ink absorber made of a fiber bundle and is allowed to flow out from a pen body made of a processed fiber product.
